(19) United States
(12) Patent Application Publication
(10) Pub. No.: US 2013/0332193 A1
(43) Pub. Date: Dec. 12, 2013

(54) TECHNIQUES FOR MANAGIGN PATIENT CONSENT

(71) Applicants: Ivan K. Kiselev, Deerfiled, IL (US); Robert A. Quinn, Medinah, IL (US)

(72) Inventors: Ivan K. Kiselev, Deerfiled, IL (US); Robert A. Quinn, Medinah, IL (US)

(21) Appl. No.: 13/494,731

(22) Filed: Jun. 12, 2012

(51) Int. Cl. G06Q 50/24

(52) U.S. Cl. 705/3

(57) ABSTRACT

A method includes displaying a first page and obtaining patient insurance eligibility data. Patient consent information is requested and received from the HIE. A second page is displayed and updated consent information is obtained. The updated consent information is transmitted to the HIE.

### CROSS REFERENCE TO RELATED APPLICATIONS

[Not Applicable]

### FEDERALLY SPONSORED RESEARCH OR DEVELOPMENT

[Not Applicable]

### JOINT RESEARCH AGREEMENT

[Not Applicable]

### SEQUENCE LISTING

[Not Applicable]

### BACKGROUND OF THE APPLICATION

Generally, this application relates to managing patient consent amongst a plurality of health care providers. In particular, this application relates to techniques for using a health information exchange (“HIE”) to manage patient consent.

An HIE may mobilize healthcare information electronically across organizations within a region, community or hospital system. An HIE may facilitate transferring clinical information among disparate health care information systems. An HIE may facilitate the efforts of physicians and clinicians to meet standards of patient care through electronic participation in a patient's continuity of care with multiple providers. An HIE may also reduce expenses associated with printing, mailing, scanning, faxing, or physically retrieving and filing documents (for example, patient charts, test results, radiological studies, or the like).

FIG. 1 illustrates relationships of parties participating in an HIE. Patients may work for employers (or may otherwise have health insurance or coverage for healthcare) and occasionally seek healthcare services. Employers or patients may purchase health insurance policies from insurance companies and pay taxes to the federal government. Patients may see healthcare providers (for example, physicians, hospitals, clinics, labs, or the like) for healthcare services. Providers may bill insurance companies or the government (collectively, “payers”) for services rendered. The payers may pay providers for the services rendered.

Since there are multitudes of patients, providers, and payers, the information interchange may become complicated in a “many-to-many” fashion. To simplify and make the process more efficient, an HIE may serve as a communication center to transmit healthcare and financial information between involved parties.

Notwithstanding these benefits, an HIE may become more feasible if patients consent to sharing of their information between healthcare organizations participating in the HIE (for simplicity, “patient consent”). The problem in obtaining consent is that it is a manual, error-prone, and paperwork-intensive procedure with no clear incentives to healthcare providers. Therefore, it may be useful to provide techniques for managing patient consent in an HIE.

### BRIEF SUMMARY OF THE APPLICATION

According to techniques of this application, a method includes executing, on at least one processor, software to display a sequence of pages on a display of a healthcare provider to request a patient's information. A first page is displayed and data including the patient's information for an insurance eligibility inquiry is obtained. While displaying the sequence of pages, data including an existing status of the patient's consent to share the patient's records amongst healthcare providers participating in the HIE is requested and received from the HIE.

A second page is displayed and data including an updated status of the patient's consent to share the patient's records amongst healthcare providers participating in the HIE is obtained. The updated patient consent status is transmitted to the HIE to update the existing status.

### BRIEF DESCRIPTION OF SEVERAL VIEWS OF THE DRAWINGS

FIG. 1 illustrates relationships of parties participating in an HIE.

FIG. 2 illustrates a system for managing patient consent, according to techniques of this application.

FIGS. 3A and 3B illustrate pages for managing patient consent, according to techniques of this application.

FIG. 4 illustrates a flowchart of a method for managing patient consent, according to techniques of this application.

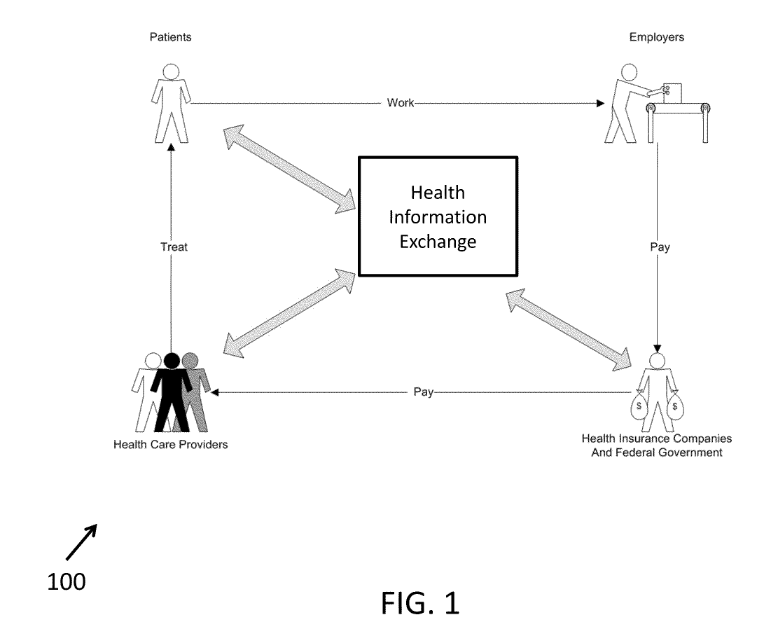

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings. Furthermore, the appearance shown in the drawings is one of many ornamental appearances that can be employed to achieve the stated functions of the system.

### DETAILED DESCRIPTION OF THE APPLICATION

Certain jurisdictions may require patients' explicit consent to transmit their information via an HIE. Getting a patient's consent may be cumbersome and may involve a lengthy process with little or no direct financial incentives for providers or payers to undertake such a process.

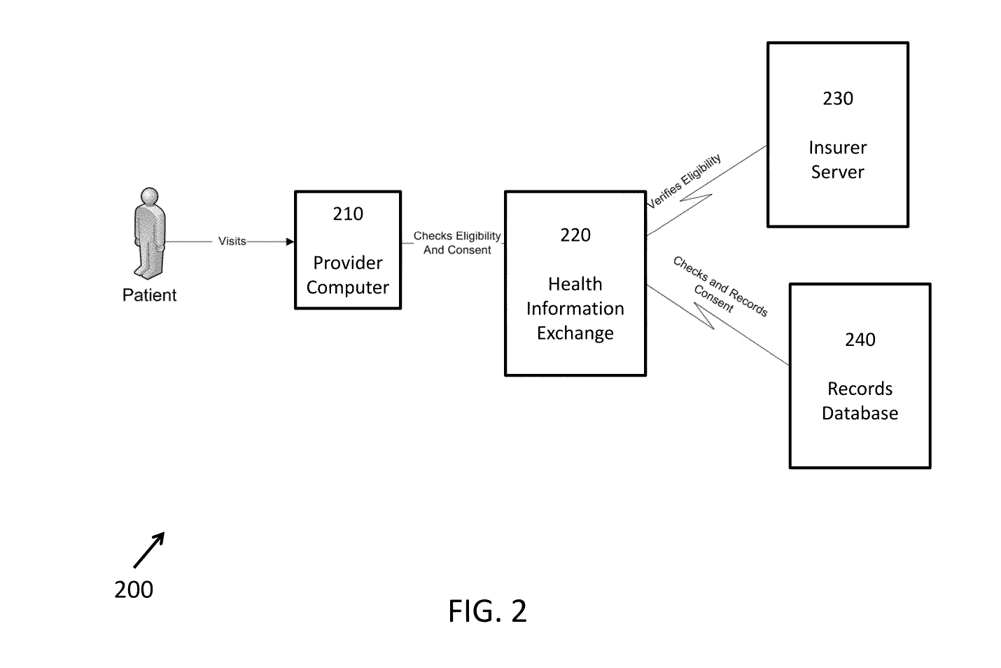

FIG. 2 illustrates a system 200 for managing patient consent, according to techniques of this application. The system 200 may include a provider computer 210, an HIE 220, an insurer server 230, and a records database 240.

A patient may visit a healthcare provider (for simplicity, “provider”) to obtain healthcare services. A provider computer 210 may be used to facilitate entering and processing information pertaining to the patient. A user may operate the provider computer 210 to enter and receive information. The provider computer 210 may include a display (for example, an LCD or CRT display), one or more processors (for simplicity, “processor”), one or more computer-readable memories (for simplicity, “memory”), and one or more user input devices. For the purposes of this application, it is to be understood that multiple user input devices (for example, a mouse, keyboard, touch screen, or the like) may be referred to as a user input device.

The provider computer 210 may communicate with the HIE 220 to check insurance eligibility and patient consent. The HIE 220 may inquire and receive insurance eligibility information from an insurer server 230. The HIE 220 may also inquire and receive a patient's consent information from a records database 240. The records database 240 may be integrated with the HIE 220 or may be referenced by a “master-patient index” in the HIE 220. The consent and insurance information may be communicated to the provider computer 210.

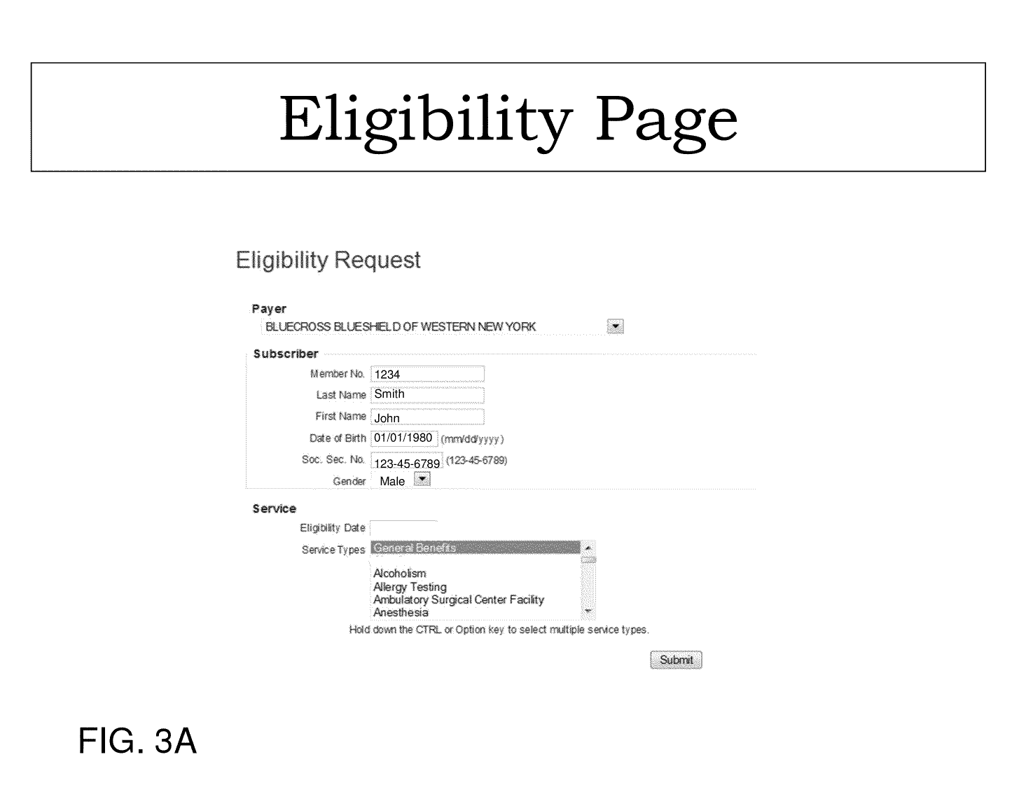

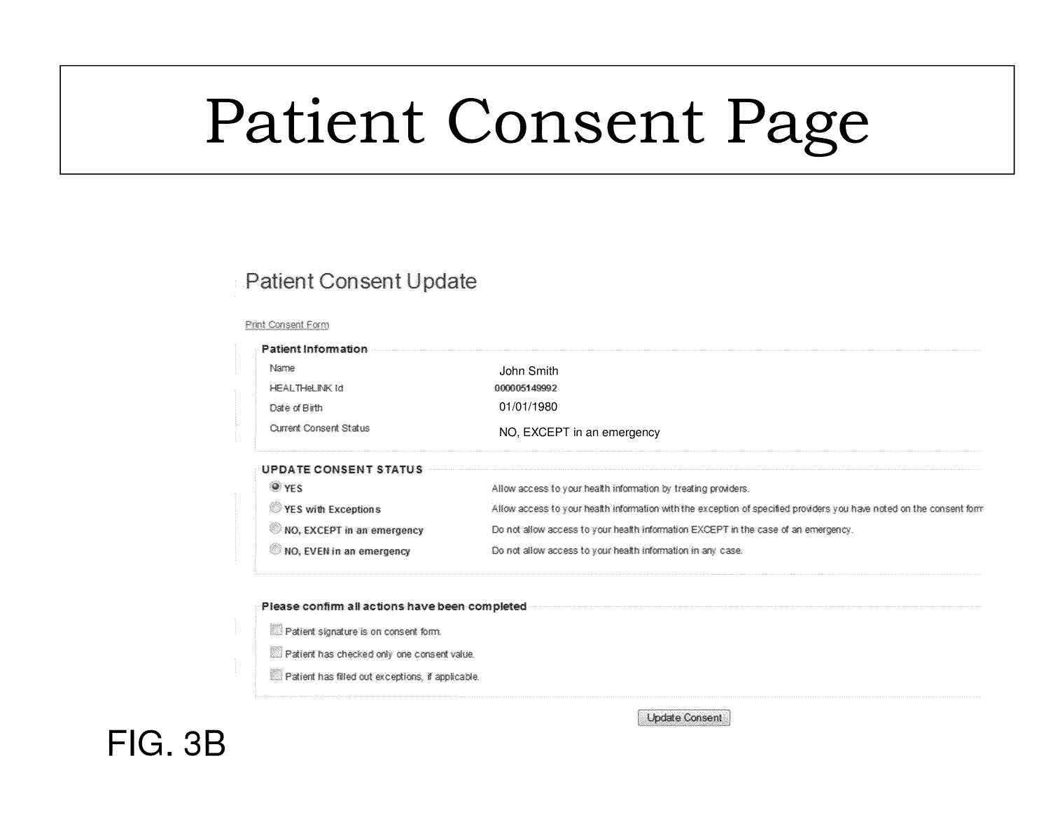

FIGS. 3A and 3B illustrate pages for managing patient consent, according to techniques of this application. The pages may be part of a sequence of pages. FIG. 3A illustrates an eligibility page. This page requests a patient's information relating to the patient's insurance eligibility. As shown, the eligibility requests information including the payer (insurer), subscriber (patient) information, and services sought. An eligibility inquiry may be transmitted to the HIE once the eligibility page has been completed.

FIG. 3B illustrates a patient consent page. The patient consent page allows updates to the patient's consent preferences. Some of the fields in the patient consent page may be automatically populated (for example, name, ID, date of birth, and current or existing consent status).

The patient consent page may also include an option to update the patient's consent status. Though not limiting, FIG. 3B shows four different consent options: (1) allow access to the patient's healthcare information by treating providers; (2) allow access to the patient's healthcare information excepting one or more treating providers; (3) do not allow access except in the case of an emergency, and (4) do not allow access in any case. A user may select between these options, for example, using radio buttons.

The patient consent page may also require additional affirmative actions to complete retrieval of updated consent information. A user may have to confirm the following: (1) the patient's signature is on a consent form; (2) the patient has checked only one consent value; and (3) the patient has indicated healthcare providers to be excepted from access to the patient's healthcare information.

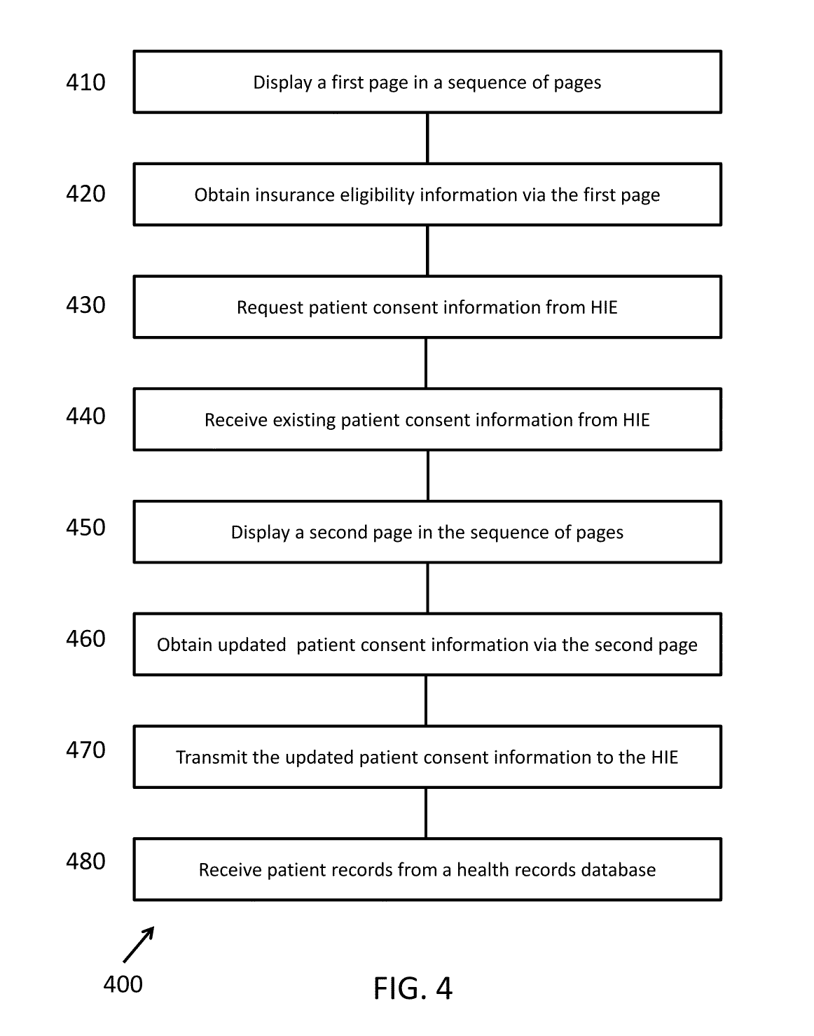

FIG. 4 illustrates a flowchart 400 of a method for managing patient consent, according to techniques of this application. The operations illustrated in the flowchart 400 may be performable at least in part by the provider computer 210. Furthermore, the operations illustrated in the flowchart 400 may be performable in a different order, or some operations may be omitted according to design and/or operational preferences. The operations illustrated in the flowchart 400, or a portion thereof, may be performable by one or more processors.

The operations illustrated in the flowchart 400, or a portion thereof, may be performable by software, hardware, and/or firmware. The method may be implemented by executing software to display a sequence of pages. The sequence of pages may be displayed on a display of a healthcare provider. The pages may prompt a user to enter the patient's information. The operations illustrated in the flowchart 400, or a portion thereof, may also be expressible through a set of instructions stored on one of more computer-readable storage media, such as RAM, ROM, EPROM, EEPROM, optical disk, magnetic disk, magnetic tape, and/or the like.

At step 410, a first page may be displayed on the display. The first page may be an insurance eligibility page, such as the one shown in FIG. 3A. The first page may prompt a user to enter in the patient's information, for example, with a user input device. At step 420, data may be obtained via the first page. The data may include the patient's information for an insurance eligibility inquiry. The data may be obtained from a user input device.

At step 430, patient consent information may be requested from the HIE. The request may be made while displaying the sequence of pages. The request may be made during the display of the first page. The request may be for data including an existing status of the patient's consent to share the patient's records amongst healthcare providers participating in the HIE. At step 440, data may be received from the HIE. The data may include the existing status of the patient's consent. The existing status of the patient's consent may be “undefined,” TRUE (allow access to the patient's healthcare information by treating providers), TRUE with exceptions (allow access to the patient's healthcare information excepting one or more treating providers), FALSE (do not allow access in any case), or FALSE except in an emergency (do not allow access except in the case of an emergency). In the case that the existing status is TRUE with exceptions, the status may also include a list of excepted healthcare providers.

At step 450, a second page may be displayed on the display. The second page may be a patient consent page, such as the one shown in FIG. 3B. The second page may be displayed subsequent to the display of the first page. The second page may prompt a user to enter in the patient's consent information, for example, with a user input device. At step 460, updated patient consent information including the status of the patient's consent may be obtained via the second page. At step 470, the updated patient consent information may transmitted to the HIE. An instruction may instruct the HIE to update the existing status of the patient's consent with the updated status of the patient's consent. The updated status of the patient's consent may be TRUE (allow access to the patient's healthcare information by treating providers), TRUE with exceptions (allow access to the patient's healthcare information excepting one or more treating providers), FALSE (do not allow access in any case), or FALSE except in an emergency (do not allow access except in the case of an emergency). In the case that the updated status is TRUE with exceptions, the status may also include a list of excepted healthcare providers. At step 480, records of the patient associated with a second healthcare provider from at least one health records database may be retrieved if such retrieval is allowed by the updated patient consent status.

The following example is illustrative of the techniques discussed above. A patient shows up in provider's office and presents an insurance card. Using a provider's computer, the office clerk checks the patient's eligibility using the HIE servers against payers' systems to make sure provider has a hope to get paid. Simultaneously with the eligibility check, the HIE searches for records of previously recorded consent to share information for this particular patient. The results of the consent search are shown to the clerk along with eligibility information. If there are no consent records, the clerk asks the patient if such consent can be obtained and updates the consent records accordingly. If there is a consent record, the patient can request a change and the clerk records the patient's wishes.

Certain operations described in this specification may be implemented in digital electronic circuitry, or in computer software, firmware, or hardware, including the structures disclosed in this specification and their structural equivalents, or in combinations of one or more of them. Certain operations may be implemented as one or more computer program products, including one or more modules of computer program instructions encoded on one or more computer-readable mediums for execution by, or to control the operation of, a data processing system. A computer-readable medium may be a machine-readable storage device, a machine-readable storage substrate, a memory device, a composition of matter affecting a machine-readable propagated signal, or a combination of one or more of them. The term “data processing systems” encompasses all apparatuses, systems, devices, and machines for processing data, including by way of example a programmable processor, a computer, or multiple processors or computers. The data processing system may include, in addition to hardware, code that creates an execution environment for the computer program in question, for example, code that constitutes processor firmware, a protocol stack, a database management system, an operating system, or a combination of one or more of them. A propagated signal is an artificially generated signal, for example a machine-generated electrical, optical, or electromagnetic signal that is generated to encode information for transmission to a suitable receiver apparatus.

A computer program (also known as a program, software, software application, script, or code) may be written in any form of programming language, including compiled or interpreted languages, and it may be deployed in any form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatuses may also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, certain operations may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Certain operations may be implemented in a computing system that includes a back-end component, e.g., as a data server, or that includes a middleware component, e.g., an application server, or that includes a front-end component, e.g., a client computer having a graphical user interface or a Web browser through which a user may interact according to techniques of this application, or any combination of one or more such back-end, middleware, or front-end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of this application or of what may be claimed, but rather as descriptions of features specific to particular techniques of this application. Certain features that are described in this specification in the context of separate techniques may also be implemented in combination in a single embodiment. Conversely, various features that are described in the context of a single embodiment may also be implemented in multiple techniques separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the techniques described above should not be understood as requiring such separation in all techniques, and it should be understood that the described program components and systems may generally be integrated together in a single software product or packaged into multiple software products.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A method comprising:
executing, on at least one processor, software to display a sequence of pages on a display of a healthcare provider to request a patient's information;
displaying, on the display, a first page of the sequence of pages;
via the first page of the sequence, obtaining, from a user input device and at the at least one processor, data including the patient's information for an insurance eligibility inquiry;
while displaying the sequence of pages, requesting, by the at least one processor and from at least one server in a health information exchange (“HIE”), data including an existing status of the patient's consent to share the patient's records amongst healthcare providers participating in the HIE;
receiving, at the at least one processor and from the at least one server in the HIE, data including the existing status of the patient's consent;
displaying, on the display, a second page of the sequence of pages;
via the second page of the sequence of pages, obtaining, from a user input device and at the at least one processor, data including an updated status of the patient's consent to share the patient's records amongst healthcare providers participating in the HIE; and
transmitting, from the at least one processor and to the at least one server in the HIE, an instruction to update the existing status of the patient's consent with the updated status of the patient's consent.

2. The method of claim 1, wherein the existing status of the patient's consent is undefined.

3. The method of claim 2, wherein the updated status of the patient's consent is at least one of TRUE, TRUE with exceptions, FALSE, and FALSE except in an emergency.

4. The method of claim 3, wherein the status TRUE with exceptions comprises consent to allow access to health information with the exception of specific providers.

5. The method of claim 1, wherein said requesting data including an existing status of the patient's consent is performed during said displaying a first page of the sequence of pages.

6. The method of claim 1, wherein said displaying a second page of the sequence of pages is performed subsequent to said displaying a first page of the sequence of pages.

7. The method of claim 1, further comprising receiving, at the at least one processor, records of the patient associated with a second healthcare provider from at least one health records database.

8. At least one non-transitory computer-readable medium comprising instructions for execution on at least one processor, wherein the instructions comprise:
execution instructions for executing, on at least one processor, software to display a sequence of pages on a display of a healthcare provider to request a patient's information;
display instructions for displaying, on the display, a first page of the sequence of pages;
obtainment instructions for, via the first page of the sequence, obtaining, from a user input device and at the at least one processor, data including the patient's information for an insurance eligibility inquiry;
requesting instructions for, while displaying the sequence of pages, requesting, by the at least one processor and from at least one server in a health information exchange (“HIE”), data including an existing status of the patient's consent to share the patient's records amongst healthcare providers participating in the HIE;
receipt instructions for receiving, at the at least one processor and from the at least one server in the HIE, data including the existing status of the patient's consent;
display instructions for displaying, on the display, a second page of the sequence of pages;
obtainment instructions for, via the second page of the sequence of pages, obtaining, from a user input device and at the at least one processor, data including an updated status of the patient's consent to share the patient's records amongst healthcare providers participating in the HIE; and
transmission instructions for transmitting, from the at least one processor and to the at least one server in the HIE, an instruction to update the existing status of the patient's consent with the updated status of the patient's consent.

9. The at least one non-transitory computer-readable medium of claim 8, wherein the existing status of the patient's consent is undefined.

10. The at least one non-transitory computer-readable medium of claim 9, wherein the updated status of the patient's consent is at least one of TRUE, TRUE with exceptions, FALSE, and FALSE except in an emergency.

11. The at least one non-transitory computer-readable medium of claim 10, wherein the status TRUE with exceptions comprises consent to allow access to health information with the exception of specific providers.

12. The at least one non-transitory computer-readable medium of claim 8, wherein said requesting data including an existing status of the patient's consent is performed during said displaying a first page of the sequence of pages.

13. The at least one non-transitory computer-readable medium of claim 8, wherein said displaying a second page of the sequence of pages is performed subsequent to said displaying a first page of the sequence of pages.

14. The at least one non-transitory computer-readable medium of claim 8, further comprising receiving, at the at least one processor, records of the patient associated with a second healthcare provider from at least one health records database.

15. A data processing system including at least one processor and at least one non-transitory computer-readable medium containing a set of instructions for execution on the at least one processor, wherein the at least one processor is configured to perform operations comprising:
executing, on at least one processor, software to display a sequence of pages on a display of a healthcare provider to request a patient's information;
displaying, on the display, a first page of the sequence of pages;
via the first page of the sequence, obtaining, from a user input device and at the at least one processor, data including the patient's information for an insurance eligibility inquiry;
while displaying the sequence of pages, requesting, by the at least one processor and from at least one server in a health information exchange (“HIE”), data including an existing status of the patient's consent to share the patient's records amongst healthcare providers participating in the HIE;
receiving, at the at least one processor and from the at least one server in the HIE, data including the existing status of the patient's consent;
displaying, on the display, a second page of the sequence of pages;
via the second page of the sequence of pages, obtaining, from a user input device and at the at least one processor, data including an updated status of the patient's consent to share the patient's records amongst healthcare providers participating in the HIE; and
transmitting, from the at least one processor and to the at least one server in the HIE, an instruction to update the existing status of the patient's consent with the updated status of the patient's consent.

16. The data processing system of claim 15, wherein the existing status of the patient's consent is undefined.

17. The data processing system of claim 15, wherein the updated status of the patient's consent is at least one of TRUE, TRUE with exceptions, FALSE, and FALSE except in an emergency.

18. The data processing system of claim 17, wherein the status TRUE with exceptions comprises consent to allow access to health information with the exception of specific providers.

19. The data processing system of claim 15, wherein said displaying a second page of the sequence of pages is performed subsequent to said displaying a first page of the sequence of pages.

20. The data processing system of claim 15, wherein the at least one non-transitory computer-readable medium contains additional instructions for execution on the at least one processor, wherein the at least one processor is configured to perform operations further comprising receiving, at the at least one processor, records of the patient associated with a second healthcare provider from at least one health records database.
